(19) United States
(12) Patent Application Publication
(10) Pub. No.: US 2026/0364796 A1
(43) Pub. Date: Nov. 19, 2026

(54) METHOD AND APPARATUS FOR COLLISION AVOIDANCE FOR A KINEMATIC STRUCTURE, AND ROBOTIC SYSTEM

(71) Applicant: Sony Group Corporation, Tokyo (JP)

(72) Inventors: Yannik NAGEL, Zurich (CH); Sina MIRRAZAVI, Morges (CH)

(21) Appl. No.: 19/136,791

(22) PCT Filed: Dec. 15, 2023
(86) PCT No.: PCT/EP2023/086173

§ 371 Date: Jun. 6, 2025

(30) Foreign Application Priority Data
Dec. 22, 2022 (EP) 22215803.2

(51) Int. Cl. B25J 9/16

(52) U.S. Cl. CPC B25J 9/1666

(57) ABSTRACT

Provided is a method of collision avoidance for a kinematic structure. The method comprises receiving input data at least indicating a current state of the kinematic structure and a current state of at least one obstacle. The method further comprises determining a target pose for a collision-free target state of the kinematic structure with respect to the at least one obstacle based on their current states. Thereby, the target pose is determined based on carrying out at least one target pose determination process, which comprises resolving, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure, and determining the target pose based on the adapted state of the kinematic structure.

### FIELD

The present disclosure relates to collision avoidance for a kinematic structure. In particular, examples of the present disclosure relate to a method and apparatus for collision avoidance for a kinematic structure, a robotic system, a non-transitory machine-readable medium, and a program.

### BACKGROUND

Kinematic structures, such as robots, computer-animated characters, etc., may be applied to a dynamic environment with stationary and dynamic objects and/or to perform time-varying and unpredictable tasks. To ensure free operation and/or safety of the kinematic structure in such applications, collisions, i.e. unintentional contacts, should be avoided. For collision avoidance, it is conceivable to find a trajectory of the kinematic structure that is globally connecting a starting configuration of the kinematic structure with a final target configuration in a collision-free way. However, practice has shown that such planning of a trajectory requires high computational effort, rendering this trajectory planning approach non-suitable for dynamic environments and/or time-critical applications. Another approach that is conceivable for collision avoidance is manipulating motion of the kinematic structure based on a local influence of objects and/or obstacles, wherein the motion manipulation is exclusively based on keeping a minimum distance between the kinematic structure and the other object all the time. This results in the motion of the kinematic structure only being influenced when the other object is already in close proximity to the kinematic structure. In other words, this collision avoidance approach rather reacts to the proximity to the other object instead of already taking active collision avoidance measures in advance. Compared to how humans and animals avoid collisions with another obstacles, such reactive behavior seems rather unnatural. This may, for example, affect the overall performance of the kinematic structure.

Hence, there may be a demand for improving collision avoidance of a kinematic structure.

### SUMMARY

This demand is met by a method of collision avoidance for a kinematic structure, an apparatus for collision of a kinematic structure, a robotic system, a non-transitory machine-readable medium, and a program in accordance with the independent claims. Advantageous embodiments are defined in the dependent claims.

According to a first aspect, the present disclosure provides a method of collision avoidance for a kinematic structure. The method comprises receiving input data at least indicating a current state of the kinematic structure and a current state of at least one obstacle. Further, the method comprises determining a target pose for a collision-free target state of the kinematic structure with respect to the at least one obstacle based on their current states. Thereby, the target pose is determined based on carrying out at least one target pose determination process that comprises resolving, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure, and determining the target pose based on the adapted state of the kinematic structure.

According to a second aspect, the present disclosure provides an apparatus for collision avoidance of a kinematic structure. The apparatus comprises interface circuitry configured to receive input data at least indicating a current state of the kinematic structure and a current state of at least one obstacle. Further, the apparatus comprises processing circuitry configured to determine a target pose for a collision-free target state of the kinematic structure with respect to the at least one obstacle based on their current states. Further, the processing circuitry is configured to determine the target pose based on carrying out at least one target pose determination process that comprises resolving, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure, and determining the target pose based on the adapted state of the kinematic structure.

According to a third aspect, the present disclosure provides a robotic system comprising an apparatus according to the second aspect, and a robotic device configured to operate based on the target pose.

According to a fourth aspect, the present disclosure provides a non-transitory machine-readable medium having stored thereon a program having a program code for performing the method according to the first aspect, when the program may be executed on a processor or a programmable hardware.

According to a fifth aspect, the present disclosure provides a program having a program code for performing the method according to the first aspect, when the program may be executed on a processor or a programmable hardware.

### BRIEF DESCRIPTION OF THE FIGURES

Some examples of apparatuses and/or methods will be described in the following by way of example only, and with reference to the accompanying figures, in which

FIG. 1 illustrates an exemplary apparatus for collision avoidance of a kinematic structure;

FIG. 2 illustrates an example of reactive collision avoidance according to prior art;

FIG. 3 illustrates an example of active collision avoidance;

FIG. 4 illustrates an exemplary apparatus for collision avoidance of a kinematic structure;

FIG. 5 illustrates an example of self-collision avoidance;

FIG. 6 illustrates an example of obstacle-collision avoidance;

FIG. 7 illustrates an example of active collision avoidance;

FIG. 8 illustrates in a flowchart an exemplary method of collision avoidance for a kinematic structure.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

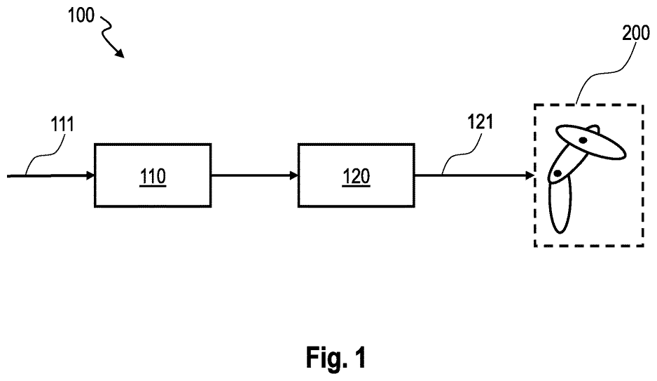

FIG. 1 illustrates an exemplary apparatus 100 for collision avoidance of a kinematic structure 200. In at least some embodiments, the apparatus 100 and the kinematic structure 200 together may form a system, and in case of the kinematic structure 200 being a robotic device form a robotic system.

The kinematic structure 200 may be any kind of controllable kinematic device or system comprising or being formed of a kinematic chain, such as a robotic device or system, an animated character used in computer animation or gaming, or the like. Thereby, the kinematic structure 200 may be applied to an industrial environment for e.g., production, logistics, or the like, or to a computer-animated or gaming environment. The kinematic chain of the kinematic structure 200 may be configurable, manipulable and/or controllable to provide or effect movement, a pose, etc., of the kinematic structure 200. For example, the kinematic chain may comprise one or more of a link, joint, actuator, manipulator, etc., which may be controlled individually or simultaneously. In some examples, the kinematic chain may at least partly form a computer animation or gaming character's skeleton, or the like, which may be configured, manipulated and/or controlled. However, it is to be noted that the kinematic structure 200 is not limited to the foregoing examples. Generally, the apparatus 100 is configured to determine a collision-free state for the kinematic structure 200, and particularly of a (target) pose thereof, with respect to itself, i.e., for self-collision or joint-collision avoidance, and/or with respect to an environment to which the kinematic structure 200 is applied, i.e., for obstacle-collision avoidance. In at least some examples, the apparatus 100 may be configured to control the kinematic structure 200 in accordance with the determined collision-free state. For the latter, the apparatus 100 may be configured to generate corresponding control data or one or more control signals to be applied to the kinematic structure 200, wherein such control data or control signal may include information about the target pose in accordance with which the kinematic structure may be controlled.

The apparatus 100 comprises at least interface circuitry 110 and processing circuitry 120. The processing circuitry 120 is operatively coupled to the interface circuitry 110.

The interface circuitry 110 is configured to receive input data 111 at least indicating a current state of the kinematic structure 200 and a current state of at least one obstacle. For example, the current state of the kinematic structure 200 may be indicated by any information describing the behavior of the kinematic structure and may comprise one or more of a shape of the kinematic structure 200, a size of the kinematic structure 200, a link position, a link velocity, a joint position, a joint velocity, a relative or absolute position of the kinematic structure 200, etc. The current state of the at least one obstacle may be indicated by any information describing the behavior of the at least one obstacle and may comprise one or more of a shape of the obstacle, a size of the obstacle, a velocity, e.g. a velocity vector, of the obstacle, a relative or absolute position of the obstacle, etc. The input data 111 may be received from any suitable data source, such as a controller, or the like, of which the apparatus 100 may be a part, which may be a part of the apparatus 100, or which forms with the apparatus 100 a system, such as robotic system, a gaming system, a computer animation system, etc. Further, the input data 111 may at least partly be obtained from one or more sensors or the like, which may also be configured to detect, observe, etc. the environment of the kinematic structure 200. It is noted that the indications of the current states of the kinematic structure 200 and the at least one obstacle may be obtained and/or collected from several different data sources.

The processing circuitry 120 is configured to receive and process the input data 111 provided by the interface circuitry 110. Accordingly, the processing circuitry 120 may be configured to receive and process information about the current state of the kinematic structure 200 and the current state of the at least one obstacle. For instance, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be operatively connected to, e.g., read only memory (ROM) for storing software, random access memory (RAM) and/or non-volatile memory. Optionally, the processing circuitry 120 may be operatively connected to a network controller to communicate via a network in order to remotely control the kinematic structure 200. Further optionally, the apparatus 100 may comprise further circuitry configured to interact with the interface circuitry 110 and/or processing circuitry 120.

In particular, the processing circuitry 120 is configured to determine the target pose for a collision-free target state of the kinematic structure 200 with respect to the at least one obstacle based on their current states as indicated by the input data 111. Thereby, the processing circuitry 120 is configured to determine the target pose based on carrying out at least one target pose determination process. According to the example illustrated in FIG. 1, the target pose of the kinematic structure 200 may be provided by the processing circuitry 120 as output, which is here denoted as target pose data 121. The target pose data 121 may be used directly to control the kinematic structure 200, or may be further processed, i.e. used indirectly to control the kinematic structure 200, as it will be described further below.

In or during the target pose determination process, the processing circuitry 120 is configured to resolve, in a region of interest (ROI) estimated based on a relative velocity between the kinematic structure 200 and the at least one obstacle in accordance with their current states as a potential region of collision, any overlap or intersection between the kinematic structure 200 and the at least one obstacle by adapting the state of the kinematic structure 200. Further, within the target pose determination process, the processing circuitry 120 is configured to determine the target pose based on the adapted state of the kinematic structure 200.

As used herein, the ROI may be understood as a potential region of collision of the kinematic structure 200 that is estimated and/or predicted in advance, e.g. for the future, i.e. when a collision is not necessarily yet imminent, based on the relative velocity between the kinematic structure 200 and the at least one obstacle in accordance with their current states. That is, the ROI described herein is considered a certain time in advance, for example one or more time units, time steps, computation steps or intervals, or the like, even before a collision is imminent, without necessarily actually constructing the ROI. Merely illustratively, the ROI may be seen as a kind of projection region into which at least relevant portions of the kinematic structure and/or the at least one obstacle may be projected, wherein it is noted that this projection into the ROI does not necessarily have to be actually performed. Thus, if there is no overlap or intersection in the ROI between the kinematic structure 200 and the at least one obstacle, a collision can be actively avoided from the beginning, i.e. is actively avoided to happen. In other words, instead of trying to reactively prevent collisions by keeping the shortest distance to the at least one obstacle, the processing circuitry 120 is configured to actively steer the kinematic structure 200 towards the target pose. However, if, in the ROI, there were an overlap and/or intersection between the kinematic structure 200 and the at least one obstacle, a collision thereof would be bound to happen at some point in the future if no countermeasures are taken, such as adapting the kinematic chain of the kinematic structure 200 or the like. It is noted that the ROI does not necessarily need to be an actual, geometrically constructed region, but is merely an illustration.

For example, the ROI may be distanced from the kinematic structure 200 and/or the at least one obstacle by a relative velocity vector indicating the relative velocity between the kinematic structure 200 and the at least one obstacle. For this, the processing circuitry 120 may be configured to determine the relative velocity between the kinematic structure 200 and the at least one obstacle by determining the relative velocity vector therebetween. Further, by way of example, the ROI may be estimated by projecting the kinematic structure and/or the at least one obstacle, by the relative velocity vector from a first position corresponding to a position according to the current states of the kinematic structure and the at least one obstacle to a second position corresponding to the ROI. In addition, the ROI may extend in more than one dimension, for example, in at least two dimensions perpendicular to the relative velocity vector, compared to merely keeping a minimum distance between the kinematic structure 200 and the at least one obstacle that may be expressed by a closest distance vector therebetween, which would merely be a one-dimensional consideration.

As mentioned above, the at least one obstacle may be or may comprise any other object present in an environment of the kinematic structure 200, wherein collision avoidance with respect to such another object may be referred to as obstacle-collision avoidance. Alternatively or additionally, the kinematic structure 200 may be divided into multiple sub-structures, for example, into its individual links, joints, manipulators, etc., and the at least one obstacle may comprise one or more of those sub-structures, wherein collision-avoidance of those sub-structures to each other may be referred to as self-collision or joint-collision avoidance.

As used herein, a pose, such as the target pose described herein, may be understood as representing a position and orientation of the kinematic chain 200 in, e.g., three dimensions or in space. The target pose may be in accordance with or may be configured to address a task to be performed by the kinematic structure 200. For example, the task to be performed may include any kind of movement in the environment or space, interaction with or manipulation of another object, such as a tool, a production material, another computer animated character, etc., wherein neither the pose nor the task is limited herein, and/or any other kinematic action.

As used herein, the collision-free state of the kinematic structure 200 may refer to any state or configuration of the kinematic structure 200 in which a minimum distance is kept between elements within the kinematic chain to each other, also referred to as self-collision avoidance and/or joint-collision avoidance, and/or between the kinematic structure 200 or the elements of its kinematic chain and one or more obstacles, i.e., another static or dynamic object in the environment, also referred to as obstacle-collision avoidance, in order to avoid unintentional contact. Likewise, the target pose may be understood as any pose that keeps a minimum distance to the at least one obstacle. Further, in order to resolve any overlap and/or intersection between the kinematic structure 200 and the at least one obstacle in the ROI, the processing circuitry 120 may be configured to adapt the state of the kinematic structure 200 accordingly. For example, the processing circuitry 120 may be configured to adapt the state of the kinematic structure 200 by adapting one or more kinematic chain parameters of the kinematic structure 200. The one or more kinematic chain parameters may relate to one or more of the above-mentioned links, joints, actuators, manipulators, etc. of the kinematic structure 200, which may be adapted to resolve any overlap and/or intersection with the at least one obstacle in the ROI. The one or more kinematic chain parameters may refer to any parameter related to controlling the kinematic chain that can be determined and set on a collision avoidance measure, in particular motion. For example, in the case of a robotic device, the one or more kinematic chain parameters may refer to e.g., a joint, an actuator, a manipulator, or the like, and/or a velocity, acceleration etc. thereof. Also, in case of a robotic device, the kinematic chain may comprise one or more links, joints, or the like, which may be operated via one or more actuators.

It is noted that the target pose determination process described herein, which may comprise the above-described resolving of any overlap or intersection between the kinematic structure 200 and the at least one obstacle in the estimated ROI, may be carried out by the processing circuitry 120 during runtime of the kinematic structure 200 by performing a respective simulation. Alternatively, the target pose determination process may be carried out multiple times for different kinematic structure information data and obstacle information data to obtain a training data set for training a machine-learning model for determining the target pose for the kinematic structure, wherein the processing circuitry 120 may be configured to determine the target pose for the kinematic structure 200 by the trained machine-learning model during runtime of the kinematic structure 200.

It is also noted that the determining of the target pose is not limited to one obstacle only. Accordingly, the target pose may be determined for multiple obstacles and/or multiple elements of the kinematic structure 200 for self-collision avoidance, in a sequence of single determinations or for multiple determinations performed simultaneously and/or in parallel.

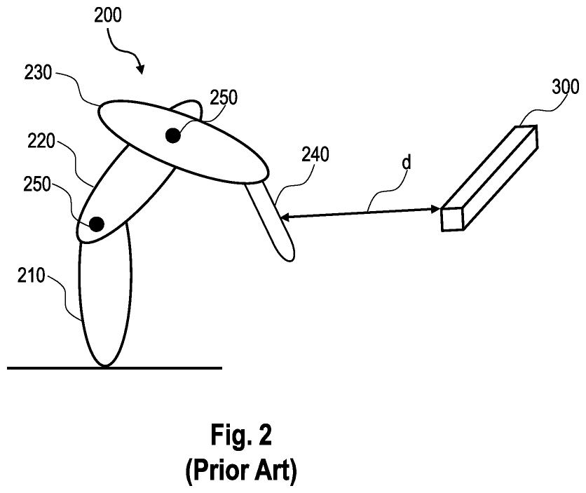

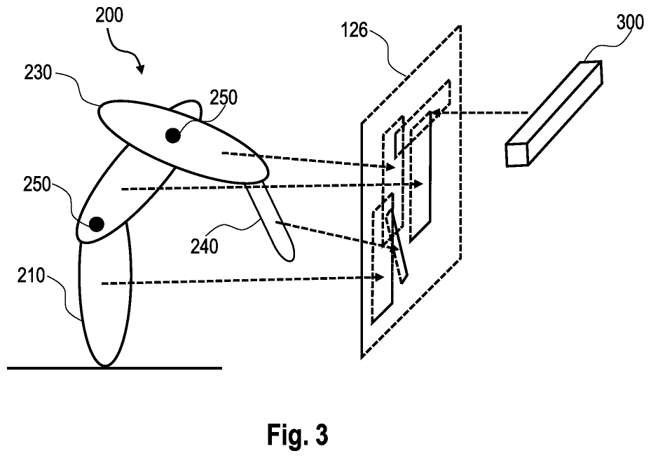

With reference to FIG. 2 and FIG. 3, both of which illustrate an example of a kinematic structure 200 and an exemplary other object, i.e. an exemplary obstacle, 300, the principle of collision avoidance described herein will now be further explained. In these examples, the kinematic structure 200 is formed as a robotic device, comprising a base (not denoted), a first link 210, a second link 220, a third link 230 and an end effector 240, i.e., the last or most distal link from the base of the kinematic structure 200. The kinematic structure 200, i.e., the robotic device, comprises a number of joints 250 connecting neighboring links 210, 220, 230, 240 with each other. It should be noted that although the kinematic structure 200 according to FIGS. 2 and 3 is a six-axis robotic device, the kinematic structure 200 described herein is not limited thereto, and the proposed collision avoidance may also be applied to a robotic device having another configuration. Further, as described herein, the proposed collision avoidance may also be applied to computer animation or gaming, wherein the kinematic structure 200 may be a computer animated or gaming character, or the like.

It is noted that FIG. 2 and FIG. 3 illustrate the kinematic structure 200 as a collision representation which can optionally be utilized as a simplified representation, model, or the like, of the kinematic structure 200 to minimize the computational effort for collision avoidance. For this, the collision representation of the kinematic structure 200 may comprise a number of bodies from and to which e.g., distances can be computed with little computational effort. Optionally, information about a gradient of a closest distance from or to, and/or between, the bodies may be determined. For instance, the bodies may be provided by one or more model, e.g., 3D models, such as mesh-files, or the like, of the links and/or primitive shapes, allowing an efficient distance computation. By way of example, FIGS. 2 and 3 illustrate a four-body collision representation with each of the links 210, 220, 230, 240 forming one body. However, utilizing the collision representation is not mandatory and FIGS. 2 and 3 only serve to explain the proposed collision avoidance.

Further, it is noted that FIG. 2 and FIG. 3 illustrate the obstacle 300 as a primitive part in the form of a cuboid. However, the shape, size, etc. of the obstacle 300 is not limited thereto, but may be of a different shape, size, etc. Accordingly, the obstacle 300 as illustrated in FIG. 2 and FIG. 3 is for illustrative purposes only.

FIG. 2 illustrates an example of the kinematic structure 200, which is formed as a robotic device that may be controlled to perform any suitable task. As mentioned above, the principle of collision avoidance described herein may also be referred to as active collision avoidance as distinguished from reactive collision avoidance, in which only the one-dimensional distance between a kinematic structure and an obstacle is kept. For better understanding this distinction between the active collision avoidance as described herein and the reactive collision avoidance according to prior art, FIG. 2 illustrates an example of such reactive collision avoidance, according to prior art, which is to be improved, added or replaced with the (active) collision avoidance described herein.

As illustrated in FIG. 2, there may be defined a closest distance vector d between the kinematic structure 200 and the obstacle 300. The principle of the reactive collision avoidance is to determine this closest distance vector d, e.g. by detecting the presence of the obstacle by a distance sensor or the like (not shown), and to keep the corresponding distance on a certain value, at least at a value above zero, e.g. by controlling motion of the kinematic structure 200 accordingly. Thereby, the closest distance vector d may be one single vector connecting the closest points between the kinematic structure 200 and the obstacle 300. That is, however, in reactive collision avoidance, the kinematic structure 200 is merely controlled to react only when the immediate presence of the obstacle 300 is detected.

FIG. 3 illustrates an example of active collision avoidance as described herein. Unlike the example according to FIG. 2, here the ROI described above is illustrated and denoted by reference sign 126. It is noted again that the ROI 126 only serves for illustrative purposes and does not have to be actually constructed by the processing circuitry 120, which is indicated in FIG. 3 by using dashed lines.

As described above, the ROI 126 is estimated, e.g. predicted, modelled, or the like, based on the relative velocity between the kinematic structure 200 and the obstacle 300 in accordance with their current states as a potential region of collision. For example, the ROI 126 may be estimated by projecting the kinematic structure 200 and/or the obstacle 300, by the relative velocity vector indicating the relative velocity between the kinematic structure 300 and the obstacle 300 from a first position corresponding to a position according to the current states of the kinematic structure 200 and the obstacle 300 to a second position corresponding to the region of interest. In the example illustrated in FIG. 3, the respective first position is indicated by solid lines and the respective second position, which may due to the above-described projection also be referred to as a virtual or imaginary position, is indicated by dashed lines. The projection itself is indicated by dashed arrows extending from the kinematic structure 200 or from the obstacle 300 to the ROI 126. It is again noted that the projections have not to be actually or geometrically performed but may serve for illustration purposes only.

According to FIG. 3, the ROI 126 is exemplarily illustrated as a plane perpendicular to the relative velocity (vector) between the kinematic structure 200 and the obstacle 300. By way of example, the ROI 126 may be distanced from the kinematic structure 200 and/or the obstacle 300 by the relative velocity vector. Into this plane are projected the cross-sections of the kinematic structure 200, here comprising, for example, the cross-sections of the links 210, 220, 230, 240, and the obstacle 300. Accordingly for better illustration, the ROI 126 may be understood as an imaginary plane comprising orthogonal projections of the kinematic structure 200 and the obstacle 300. By considering the relative velocity (vector) between the kinematic structure 200 and the obstacle 300, the ROI 126 includes or may be understood as a time-based prediction of where the kinematic structure 200 and the obstacle 300 will be located in a future time based on their current states and if no countermeasure is taken.

Further according to FIG. 3, the cross sections projected into the ROI 126 overlap or intersect at least partially with each other. In this example, each overlap or intersection between the projected cross-sections of the kinematic structure 200, i.e. between the cross-sections of the links 210, 220, 230, 240, may be understood as a potential self-collision. Likewise, in this example, each overlap or intersection between the projected cross-sections of the kinematic structure 200 and the obstacle 300 may be understood as a potential obstacle-collision.

The principle of (active) collision avoidance described herein is based on the processing circuitry 120 being configured to resolve any of the above overlaps and intersections in the ROI 126. For this, as described above, the processing circuitry 120 is configured to resolve, in the ROI 126, any overlap or intersection between the kinematic structure 200 itself and/or between the kinematic structure 200 and the obstacle 300 by adapting the state of the kinematic structure 200, thereby obtaining the target pose to be output as the above-described target pose data 121 (see FIG. 1). The resolving of any overlap or intersection between the kinematic structure 200 and the obstacle 300 may comprise adapting the state of the kinematic structure 200 to keep a minimum distance between its links 210, 220, 230, 240 and/or between the kinematic structure 200 and/or the obstacle 300. In other words, the projected cross-sections in the ROI 126 may be shifted in such a way that there is a minimum distance between all cross-sections (shown here as dashed lines). For example, the processing circuitry 120 may be configured to adapt e.g. the position of the respective link 210, 220, 230, 240, within the ROI 126 so as to not overlap or intersect any more with each other and/or with the obstacle 300. The sum of these adaptations of the state of the kinematic structure 200 may form the target pose to be output as the above-described target pose data 121.

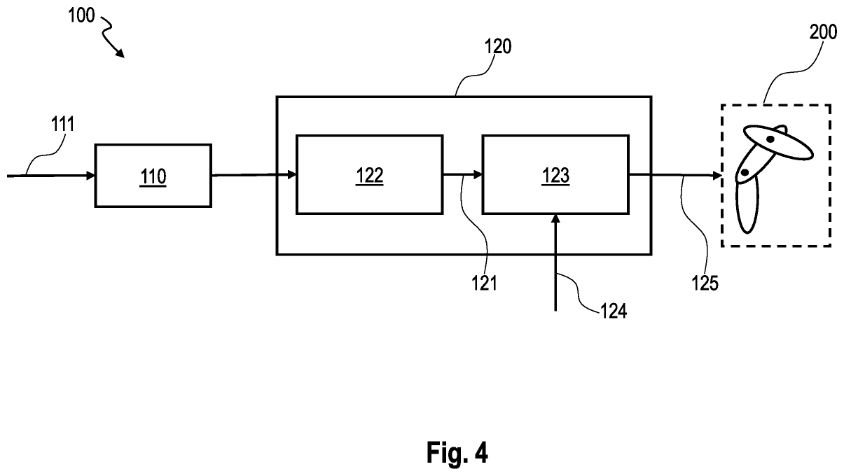

FIG. 4 illustrates another exemplary apparatus for collision avoidance of a kinematic structure, on the basis of which the determination and particularly the use of the target pose described above will be further described.

As illustrated in FIG. 4, in at least some examples, the processing circuitry 120 may comprise a first function block, module or sub-circuitry 122 configured to carry out the target pose determination process described above and to output the target pose of the kinematic structure 200 as the above-described target pose data 121.

Further, the processing circuitry 120 may comprise a second function block, module or sub-circuitry 123 configured to receive the target pose data 121 from the first function block, module or sub-circuitry 122. The second function block, module or sub-circuitry 123 may be configured to additionally receive time data 124 indicating an update interval used to control the kinematic structure 200. As used herein, the update interval may be received from any type of timer configured to indicate a system time. The update interval may also be referred to as a computation interval, a time step, a system frequency, or the like. For instance, the update interval may be a computation interval, a frequency, or the like, with which the kinematic structure 200 and/or a system to which the kinematic structure 200 is applied to, such as a robotic system, a computer animation or gaming environment, or the like, is updated, e.g., operated, controlled, etc. That is, the processing circuitry 120 is configured to receive and process the target pose data 121 and the time data 124.

In addition, the second function block, module or sub-circuitry 123 may be configured to perform a constrained optimization process on inverse kinematics of the target pose, i.e. target pose data 121, in accordance with the time data 124 to obtain for the respective update interval one or more kinematic chain parameters associated with the collision-free target state of the kinematic structure and to generate control data 125 for controlling the kinematic structure 200 based on the one or more kinematic chain parameters.

As used herein, the inverse kinematics may be understood as a computational process of determining, calculating, or the like, one or more variable kinematic chain parameters configured to place one or more elements of the kinematic chain, such as a link, a joint, a manipulator, an animation or a gaming character's skeleton, in a given position and orientation, i.e., a pose, relative to a start of the kinematic chain. In case of a robotic device, the start of the kinematic chain may be a base of the robotic device.

The optimization process, as used herein, may be understood as a computational process of determining, e.g., finding, a preferred, e.g., the best, etc., or generally an optimized, solution from a set of feasible alternatives for the collision-free state of the kinematic structure 200. For example, the problem underlying the optimization process may be formulated according to the following mathematical expression:

$$min \frac{1}{2} {x}^{T} P x + {q}^{T} x \qquad ( Eq . 1 )$$

$$subject to Gx \leq h$$

$$Ax = b$$

$${x}_{min} \leq x \leq {x}_{max}$$

$$with x = \dot{q} ,$$

With P denoting a matrix representing one or more objectives, q^{T} denoting a vector representing one or more objectives, G denoting a (n) (inequality) constraint matrix, h denoting a (n) (inequality) constraint vector, A denoting a (n) (equality) constraint matrix, b denoting a (n) (equality) constraint vector and \dot{q} denoting a joint velocity. Accordingly, the problem is formulated as a convex optimization exclusively utilizing convex cost functions and constraints, resulting in fast computation. In at least some examples, the optimization process on the inverse kinematics utilizes quadratic programming, utilizing quadratic and linear cost functions. However, it is to be noted that the present disclosure is not limited to the above example. Any other suitable method for formulating the problem may be utilized as well. In general, the processing circuitry 120, and particularly its second function block, module or sub-circuitry 123, is configured to determine, by performing the optimization process, such kinematic chain parameters and/or states of the kinematic structure 200 not violating the one or more constraints for or associated with the collision-free state to obtain optimized one or more kinematic chain parameters.

Thereby, the inverse kinematics may be solved on the level of joint angle velocities due to the convex relationship between joint angle velocity and spatial velocity of any point on the kinematic structure 200 according to the following mathematical expression:

$$\dot{x} = J ( q ) \dot{q} , \qquad ( Eq . 2 )$$

with \dot{x} denoting a task space velocity, J(q) denoting a Jacobian matrix, and \dot{q} denoting the above joint velocity. However, it is to be noted that the present disclosure is not limited to the above example. Any other suitable method for solving the inverse kinematics can be utilized as well.

For example, the optimization process may comprise defining and/or solving a number of objectives at least for or associated with one or more of self-collision avoidance and/or joint-collision avoidance, and/or obstacle-collision avoidance to obtain optimized one or more kinematic chain parameters for the collision-free state. For instance, the optimization process may utilize a number of, i.e., one or more, cost functions and/or constraints to define and/or solve the number of objectives. By way of example, the number of objectives for the optimization problem underlying the optimization process to be performed by the processing circuitry 120 may be formulated according to the following mathematical expression:

$$P = {P}_{t} + {P}_{a c c} \qquad ( Eq . 3 )$$

$${q}^{T} = {q}_{t}^{T} + {q}_{s c}^{T} + {q}_{o c}^{T} + {q}_{a c c}^{T}$$

$$G = [ {G}_{s c} {G}_{o c} {G}_{j} {G}_{a c c} ]$$

$$h = [ {h}_{s c} {h}_{o c} {h}_{j} {h}_{a c c} ] ,$$

wherein each objective may produce an independent matrix Pᵢ and/or an independent vector

$${q}_{i}^{T}$$

and/or an independent matrix. The indices of Pᵢ and

$${q}_{i}^{T}$$

are denoted to mean t: (last link or end effector) tracking, sc: self-collision avoidance and/or joint collision avoidance, oc: obstacle-collision avoidance, acc: acceleration and/or motion smoothness, and j: joint limit(s). These indices or abbreviations for tracking t, self-collision avoidance and/or joint-collision avoidance sc, obstacle-collision avoidance, acceleration or motion smoothness acc and joint limit(s) j are used throughout this disclosure where appropriate. It is noted that for mere collision avoidance, the terms and/or equations denoted by the index sc and/or oc are sufficient, while the further terms and/or equations denoted by t, acc and/or j are optional. The individual output for matrix Pᵢ and vector

$${q}_{i}^{T}$$

may be combined, e.g., added, to create the final P matrix and q^{T} vector of the total optimization problem according to Eq. 1. The individual constraint matrices Gᵢ and vectors hᵢ may also be combined, e.g., added or stacked together. Constraining the optimization process, for example, may comprise utilizing one or more constraints separating an admissible, collision-free space of the kinematic structure 200 from a non-collision-free, forbidden space of the kinematic structure 200. This is denoted by the above indices sc, i.e., self-collision avoidance, and oc, i.e., obstacle-collision avoidance, for Pᵢ and

$${q}_{i}^{T} .$$

Further, one or more constraints may relate to one or more hardware limitations, such as a joint limit, a joint angle limit, a joint velocity limit, a joint acceleration limit, an acceleration limit, a jerk limit, or the like, of the kinematic structure 200. This is denoted by the above index j for Pᵢ and

$${q}_{i}^{T} .$$

In at least some examples, one or more constraints may relate to motion smoothness, considering e.g., an acceleration limit, a jerk limit, or the like, desired for operating the kinematic structure 200. This is denoted by the above index acc for Pᵢ and

$${q}_{i}^{T} .$$

Generally, the one or more constraints may set boundaries within which a full state space is available for determining optimized one or more kinematic chain parameters through the inverse kinematics.

Further, the processing circuitry 120 is configured to generate, based on the determined one or more kinematic chain parameters, the above-mentioned control data 125 for controlling the kinematic structure 200. For this, the apparatus 100 may comprise a data interface to the kinematic structure 200 and/or to a related robotic system, a computer animation environment or engine, or a gaming environment or engine, or the like. The control data 125 may be configured to control e.g., motion of the kinematic structure 200 under collision avoidance, e.g., by controlling corresponding actuators, joints, links, etc. of the kinematic structure 200 or animation or gaming engines.

By coupling the optimization-based inverse kinematics to the update interval Δt indicated by the time data 124 to carry out its full computation at each update interval, the kinematic structure 200 may be controlled under collision avoidance for even dynamic tasks and/or in unstructured and unpredictable environments, e.g., with one or more dynamic. Performing the constrained optimization process may require only little computational effort. Further, by performing the constrained optimization process on the inverse kinematics of the desired pose, the kinematic structure 200 may be controlled, based on the resulting one or more kinematic chain parameters, to operate at its limit considering feasibility.

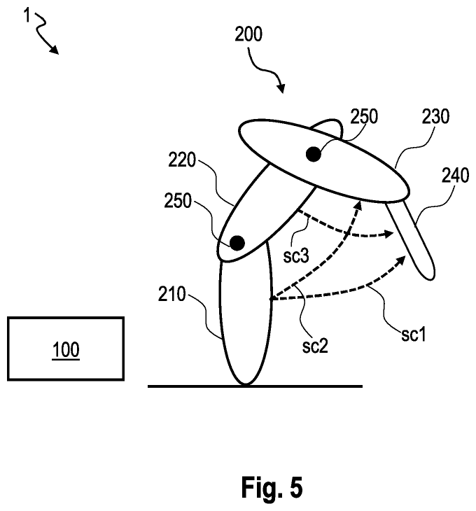

FIG. 5 illustrates an exemplary kinematic structure 200 formed as a robotic device, which may be controlled at least partly by the apparatus 100 described herein. In FIG. 5, arrows indicate three link-pair combinations sc1, sc2 and sc3, on the basis of which an example of self-collision avoidance, which may include joint-collision avoidance, for the kinematic structure 200 will be explained in the following.

In general, the processing circuitry 120 is configured, in the optimization process, to penalize closeness of elements, e.g., links, within the kinematic chain of the kinematic structure 200 to each other to obtain optimized one or more kinematic chain parameters. In other words, the processing circuitry 120 may be configured, in the optimization process, to find one or more kinematic chain parameters for a self-collision-free state, which may be comprised by the collision-free state to be determined for the kinematic structure 200.

As used herein, the index sc of matrix Pᵢ and vector

$${q}_{i}^{T}$$

relates to self-collision avoidance. Self-collision may occur between the links 210, 220, 230, 240 resulting in a number of link-pair combinations. Thereby, the processing circuitry 120 may be configured to avoid self-collision between two consecutive of the links 210, 220, 230, 240 by determining and/or setting respective joint limit constraints in the optimization process. For the further link-pair combinations sc1, sc2 and sc3, the optimization problem may comprise a constraint according to the following mathematical expression:

$$\frac{1}{{k}_{sc}} ( d - {d}_{safety} ) \geq - \frac{δ d}{δ q} Δ t \dot{q} , \qquad ( Eq . 4 )$$

with d denoting a current distance, d_{safety} denoting a safety distance, k_{sc} denoting a feasibility scalar for self-collision, Δt denoting the update interval as provided by the time data 124 and \dot{q} denoting a joint velocity. This self-collision avoidance constraint restricts how much the shortest distance between any two links, e.g., links 210, 220, 230, 240 are allowed to change within the update interval Δt. The shortest distance between each link pair may be defined by Points P1 and P2 which are closest to each other for each link pair. The distance travelled within the update interval Δt by applying any joint velocity at the beginning of the update interval Δt is described by the right side of inequality Eq. 4. Restricting this distance to less or equal than the distance itself, be reduced by defining the safety distance d_{safety}, on the left side of the inequality Eq. 4 results in not reaching any distance less than the safety distance d_{safety}. Based on this, the processing circuitry 120 is configured to establish self-collision avoidance. The feasibility of the forgoing self-collision constraint may be provided by the feasibility scalar k_{sc}≥1 defining how fast the distance d is allowed to reach the safety distance d_{safety}, thereby indicating how much joint acceleration is to be applied to comply with this boundary. However, it is to be noted that the present disclosure is not limited to the above example. Any other suitable method for self-collision can be utilized as well. It is noted that the number of further link-pair combinations sc1, sc2 and sc3, which may also be referred to as the number of collision pairs, may be determined, for example, by the mathematical expression

$${n}_{P} = {\sum }_{i = 2}^{i = {n}_{L}} {n}_{L} - i ,$$

with nₚ denoting the number of collision pairs and n_{L} denoting the number of links of the kinematic structure 200.

Referring again to FIG. 4, comparing Eq. 4 with the optimization problem according to Eq. 1 provides, for the self-collision avoidance, the following mathematical expression:

$${G}_{sc} = - \frac{δ d}{δ q} Δ t \qquad ( Eq . 5 )$$

$${h}_{sc} = \frac{1}{{k}_{sc}} ( d - {d}_{safety} ) .$$

This constraint may provide feasible self-collision avoidance. However, in order to minimize bouncy maneuvers of the kinematic structure 200, an optional cost function may be utilized according to the following mathematical expression:

$$\begin{matrix}min \\ \dot{q}\end{matrix} - {w}_{sc} \frac{1}{d} \frac{δ d}{δ q} \frac{δ q}{δ t} , \qquad ( Eq . 6 )$$

with w_{sc} denoting a weight of the self-collision avoidance cost function. Eq. 6 is based on the logarithm of the distance. Thereby, to create a dependency on the joint angle velocity, the time derivative of the logarithm is utilized.

Further, in at least some examples, the cost function Eq. 6 may be incorporated into the optimization process according to the following mathematical expression:

$${q}_{sc}^{T} = - {w}_{sc} \frac{1}{d} \frac{δ d}{δ q} , \qquad ( Eq . 7 )$$

by which the gradient of the distances with respect to the joint angles may be determined. At least some embodiments, however, may utilize a more efficient way for determining the gradient according to the following mathematical expression:

$$\frac{δ d}{δ q} = - \frac{1}{d} {( {P}_{1} - {P}_{2} )}^{T} ( {J}_{{P}_{1}} - {J}_{{P}_{2}} ) , \qquad ( Eq . 8 )$$

with P₁ denoting a first closest point, P₂ denoting a second closest point, J_{P}_{₁} denoting a Jacobian of P₁ and J_{P}_{₂} denoting a Jacobian of P₂. However, it is noted that it is not mandatory to subtract the full Jacobians. Rather, only for those joints i that may cause a relative motion between P₁ and P₂, i.e., for those joints that lie between P₁ and P₂ in the kinematic chain, may be considered according to the following mathematical expression, distinguishing a revolute joint j and a prismatic joint j:

$$revolute joint : {j}_{{P}_{1 , i}} - {j}_{{P}_{1 , i}} = - \vec{{θ}_{ι}} \times ( \vec{{r}_{{P}_{2}}} - \vec{{r}_{{θ}_{ι}}} ) \qquad ( Eq . 9 )$$

$$prismatic joint : {j}_{{P}_{1 , i}} - {j}_{{P}_{1 , i}} = - \vec{{θ}_{ι}} ,$$

with j_{P}_{_{1,i}}-j_{P}_{_{1,i}} denoting an entry i of difference J_{P}_{₁}-J_{P}_{₂}, \vec{θᵢ} an axis of motion of joint i, [symbol] denoting a position vector to P₂ and [symbol] denoting a position vector to joint i. By optionally utilizing Eq. 9, determining of the distance gradient may be reduced to only one cross product for revolute joints between P₁ and P₂, which can even be omitted in case of a prismatic joint since this information may be directly derived from forward kinematics, for which the processing circuitry 120 may also be configured.

The feasibility scalar k_{sc} may be determined in several ways. For example, the feasibility scalar k_{sc} and/or a constant, minimum value of the feasibility scalar k_{sc} may be determined according to the following mathematical expression:

$$\frac{d}{{( {k}_{sc} Δ t )}^{2}} \leq \frac{δ d}{δ q} {\ddot{q}}_{lim} , \qquad ( Eq . 10 )$$

with \ddot{q}ₗᵢₘ denoting a joint acceleration limit (min/max). Thereby, worst case scenarios of Eq. 10 may be determined. Eq. 10 depends on the geometry, expressed by d, the joint acceleration limit(s), expressed by

$$\frac{δ d}{δ q} {\ddot{q}}_{lim}$$

and the update interval Δt. It is noted that Eq. 4 may alternatively be determined in real time by inputting a current value of distance d and

$$\frac{δ d}{δ q} .$$

Alternatively or additionally to Eq. 10, a value of the feasibility scalar k_{sc} may be determined without determining the geometric relationship in Eq. 10. For example, the value of the feasibility scalar k_{sc} may be determined according to the following mathematical expression:

$${k}_{sc} \geq ceil ( maximum ( \frac{{\dot{q}}_{max}}{\vert {\ddot{q}}_{min} \vert Δ t} , \frac{\vert {\dot{q}}_{min} \vert}{{\ddot{q}}_{max} Δ t} ) ) , \qquad ( Eq . 11 )$$

with \dot{q}ₘᵢₙ denoting a minimum joint velocity, \dot{q}ₘₐₓ denoting a maximum joint velocity, \ddot{q}ₘᵢₙ denoting a minimum joint acceleration, \ddot{q}ₘₐₓ denoting a maximum joint acceleration, maximum ( ) denoting an operation that determines the maximum value among a given set of values and ceil ( ) denoting an operation that rounds ab any floating point number to the next integer. Eq. 11 considers the highest possible rate of change at which the shortest distance might be reduced. If the feasibility scalar k_{sc} is determined according to Eq. 11, joint velocity q may be determined to avoid self-collision, wherein its execution is actually feasible for the kinematic structure 200.

It is noted that the feasibility scalar k_{sc} determined according to Eq. 11 is constant which may result in a motion of the kinematic structure 200 that is, in at least certain situations or scenarios, more conservative than needed as it is evaluated for worst case scenarios. Therefore, in at least some examples, the feasibility scalar k_{sc} may be determined, e.g., computed, online by utilizing the actual joint velocity \dot{q} instead of global worst-case scenarios \dot{q}ₘₐₓ and/or \dot{q}ₘᵢₙ. For example, an alternative way to determine the feasibility scalar k_{sc} may utilize the following mathematical expression:

$${k}_{sc} ( t ) \geq ceil ( maximum ( \frac{\vert \dot{q} ( t ) \vert}{\vert {\ddot{q}}_{max / min} \vert Δ t} ) , \qquad ( Eq . 12 )$$

with \dot{q}(t) denoting a current joint velocity. Depending on whether \dot{q}(t) has a positive or negative value, \ddot{q}ₘᵢₙ or \ddot{q}ₘₐₓ may be chosen. Thereby, determining the feasibility scalar k_{sc} according to Eq. 12 defines a self-collision avoidance boundary that exerts maximum joint acceleration \ddot{q}ₘᵢₙ or \ddot{q}ₘₐₓ along the entire boundary so as to exhibit a most agile collision avoidance behavior.

Another alternative way to determine the feasibility scalar k_{sc} may be empirically in simulation.

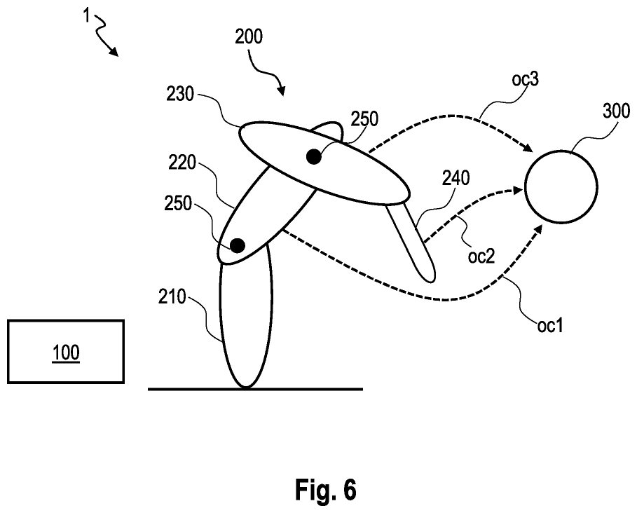

FIG. 6 illustrates an exemplary kinematic structure 200 formed as a robotic device, which may be controlled at least partly by the above apparatus 100. In FIG. 6, arrows indicate three link-obstacle combinations oc1, oc2 and oc3 with respect to an exemplary obstacle 300 present in the environment of the kinematic structure 200, on the basis of which an example of obstacle-collision avoidance for the kinematic structure 200 will be explained in the following. Each of the link-obstacle combinations oc1, oc2 and oc3 relates to a collision path between the respective link 220, 230 and 240 and the obstacle 300. It is noted that the obstacle-collision avoidance may be performed with respect to one or more stationary and/or dynamic obstacles 300. It is further noted that the processing circuitry 120 may be configured, in the optimization process, to find one or more kinematic chain parameters for an obstacle-collision-free state, which may be comprised by the collision-free state to be determined for the kinematic structure 200. In at least some examples, the collision-free state of the kinematic structure 200 to be determined may comprise self-collision and/or joint-collision avoidance, and/or obstacle-collision avoidance.

In general, the processing circuitry 120 is configured, in the optimization process, to penalize closeness of the kinematic chain of the kinematic structure 200 to obtain optimized one or more kinematic chain parameters. For example, this may be expressed by the following mathematical expressions:

$$\begin{matrix}min \\ \dot{q}\end{matrix} - {w}_{oc} \frac{1}{d} \frac{δ d}{δ q} \frac{δ q}{δ t} \qquad ( Eq . 13 )$$

$${q}_{oc}^{T} = - {w}_{oc} \frac{1}{d} \frac{δ d}{δ q} , \qquad ( Eq . 14 )$$

with w_{oc} denoting a weight of the obstacle-collision avoidance cost function. It is noted that Eq. 13 and Eq. 14 regarding obstacle-collision avoidance at least largely correspond to Eq. 6 and Eq. 7 above regarding self-collision avoidance, and a repetition of that description is omitted here.

As above for self-collision avoidance, the optimization problem for obstacle-collision avoidance may comprise one or more constraints according to the following mathematical expressions:

$$\frac{1}{{k}_{oc}} ( d - {d}_{safety} ) + \frac{δ {d}_{o}}{δ q} Δ t \geq - \frac{δ d}{δ q} Δ t \dot{q} \qquad ( Eq . 15 )$$

$${G}_{oc} = - \frac{δ d}{δ q} Δ t \qquad ( Eq . 16 )$$

$${h}_{oc} = \frac{1}{{k}_{oc}} ( d - {d}_{safety} ) + \frac{δ {d}_{o}}{δ q} \qquad ( Eq . 17 )$$

with dₒ denoting a current distance to the obstacle 300 and k_{oc} a feasibility scalar for obstacle-collision. These one or more constraints at least largely correspond to the constraints for self-collision according to Eq. 4 and 5 above. Therefore, reference is made to the above description regarding self-collision and a repetition of that description is omitted here.

It is noted that obstacle-collision avoidance differs from self-collision avoidance, for example, in that the position P and velocity v of an obstacle, i.e., the obstacle 300, cannot be influenced by the kinematic structure 200 itself, e.g., by its joint angles etc. Further, it is noted that when collision is to be avoided with an obstacle, e.g., obstacle 300 in FIG. 6, the constraint Eq. 15, and optionally the cost function Eq. 13, is to be added to the optimization problem of the optimization process for a number of, also every, link-obstacle pair oc1, oc2 and oc3 between the kinematic structure 200 and the obstacle 300 except for the static base link. Only those collisions influenced by the joint angles of the kinematic structure 200 can possibly be avoided by the motion of the kinematic structure 200. This, however, does not necessarily apply to the static base link of the kinematic structure 200 such that it does not need to be considered. Therefore, the number of collision pairs n_{P} may be determined, for example, by the mathematical expression n_{P}=n_{L}−1, with n_{L} denoting the number of links.

Further, due to the foregoing description, the gradient of the distance with respect to joint angles has only one Jacobian entry, namely for the closest point of the kinematic structure 200, which may be expressed according to the following mathematical expressions:

$$\frac{δ d}{δ q} = \frac{1}{d} {( {P}_{r} - {P}_{o} )}^{T} {J}_{{P}_{r}} \qquad ( Eq . 18 )$$

$$\frac{δ {d}_{o}}{δ t} = \frac{1}{d} {( {P}_{r} - {P}_{o} )}^{T} {v}_{{P}_{o}} , \qquad ( Eq . 19 )$$

with Pᵣ denoting a closest point on the kinematic structure 200, Pₒ denoting a closest point on the obstacle, J_{P}_{ᵣ} denoting a Jacobian of Pᵣ and v_{P}_{ₒ} a velocity vector of Pₒ on the obstacle, e.g. obstacle 300 in FIG. 3. It is noted that information data regarding the obstacle, e.g., the obstacle 300, may be received by the processing circuitry 120, via the interface circuitry 110, from any suitable data source, such as one or more sensors, or the like, configured to indicate a current state of the kinematic structure 200 and/or a current state of the obstacle 300. Based on such information, the processing circuitry 120 may be configured to determine Pₒ, v_{P}_{ₒ}, etc. Further, it is noted that the forgoing example may allow collision avoidance with regard to both static and dynamic, e.g., moving, obstacles present in the environment of the kinematic structure 200.

For determining the feasibility scalar k_{oc} for obstacle-collision avoidance, reference is made to the above description regarding determining the feasibility scalar k_{sc} for self-collision avoidance. The feasibility scalar k_{oc} for obstacle-collision avoidance oc may be determined in a similar or same manner and a repetition of that description is omitted here.

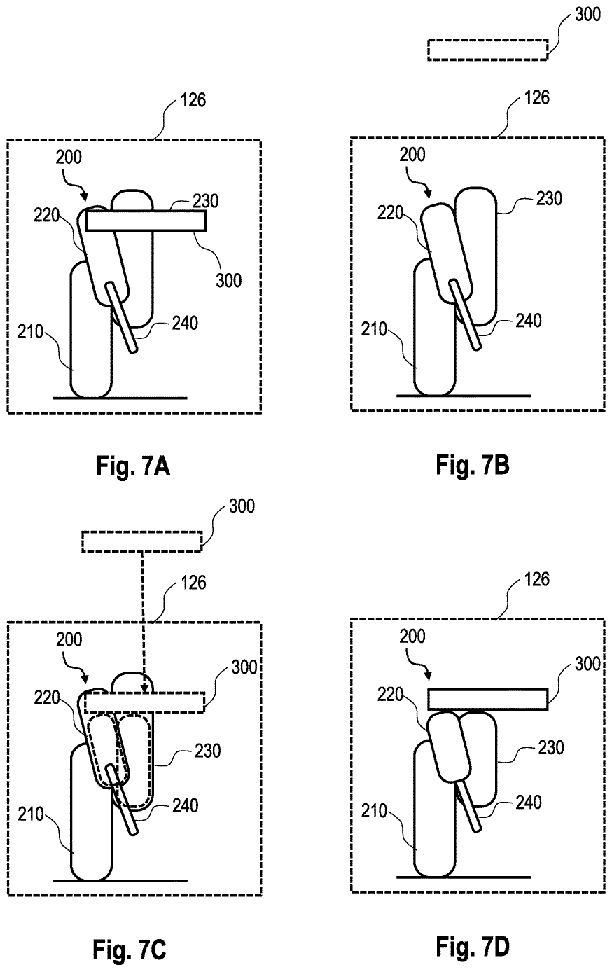

FIG. 7 illustrates in sub-FIGS. 7A to 7D an example of the above-described target pose determination process carried out by the processing circuitry 120. In particular, sub-FIGS. 7A to 7D illustrate the above-described ROI 126, which is estimated based on the relative velocity between the kinematic structure 200 and the obstacle 300 and into which both are projected as described above. This example may be applied regardless of whether self-collision avoidance or obstacle-collision avoidance is to be performed for the kinematic structure 200, wherein in case of self-collision avoidance the at least one obstacle 300 may be formed by or may comprise, for example, the link-pair combinations sc1, sc2 and sc3 as illustrated in FIG. 5. It is noted that the present disclosure is not limited to this example and the target pose determination process may be carried out in a different way.

As described above, the target pose determination process, which may comprise the above-described resolving of any overlap or intersection between the kinematic structure 200 and the at least one obstacle in the estimated ROI 126 (see e.g. FIG. 3), may be carried out by the processing circuitry 120 during runtime of the kinematic structure 200 by performing a respective simulation. Alternatively, the target pose determination process may be carried out multiple times for different kinematic structure information data and obstacle information data to obtain a training data set for training a machine-learning model for determining the target pose for the kinematic structure, wherein the processing circuitry 120 may be configured to determine the target pose for the kinematic structure 200 by the trained machine-learning model during runtime of the kinematic structure 200.

According to the example of FIG. 7, the resolving of any overlap or intersection between the kinematic structure 200 and the at least one obstacle (here, for example, obstacle 300 in case of obstacle-collision avoidance) may comprise determining a (virtual) collision-free initial state of the kinematic structure 200 with respect to the obstacle 300 by (virtually) removing the at least one obstacle from the ROI 126, and (virtually) iteratively re-introducing the obstacle 300 into the ROI 126 and adapting the initial state of the kinematic structure 200 by performing collision avoidance with respect to the at least one obstacle during its re-introduction to obtain the target pose, i.e. the target pose data 121, for the ROI 126. It is noted that, in the simulation, the above-described kinematic constraints etc., such as joint velocity, acceleration jerk, etc., may be disregarded during the target pose determination process which allows to fully introduce the at least one obstacle in one or more, few iterations.

Accordingly, when starting from the illustration in FIG. 7A, the (virtual) projections of the kinematic structure 200 and the obstacle 300 into the ROI 126 show that in this estimation a collision is imminent as there is an overlap or intersection between kinematic structure 200 and the obstacle 300. As described above, in the target pose determination process, the processing circuitry 120 is to resolve those overlaps and intersections.

According to FIG. 7B, as described above, the obstacle 300 may be (virtually) removed from the ROI 126, thereby determining a collision-free initial state of the kinematic structure 200 with respect to the obstacle 300. It is understood that if the collision-free state is maintained, no collision will occur. For example, the (virtually) removing of the obstacle 300 from the ROI 126 may be performed by extruding the virtual obstacle from its current position towards outside the ROI 126, in at least some examples to infinity, e.g. across the path of the future relative motion, e.g. perpendicular to the ROI 126. For instance, in case of the kinematic structure 200 being stationary and the obstacle 300 moving linearly, this may correspond to a linear extrusion of the obstacle 300 from its current position, i.e. its position according to its projection into the ROI 126, to e.g. infinity. In case of the kinematic structure 200 being stationary and the obstacle 300 performing a time-varying motion whose future path can be predicted, the obstacle 300 may be extruded across this non-linear path. By way of example, the extrusion may resemble a volume that will be swept by the obstacle along its future path.

Then, as illustrated in FIG. 7C, the at least one obstacle, i.e. obstacle 300 may be re-introduced into the ROI 126, wherein the processing circuitry 120 may adapt the state of the kinematic structure 200 to avoid collision with the re-introduced obstacle 300 during its re-introduction. For example, the processing circuitry 120 may be configured to adapt the kinematic chain of the kinematic structure 200 so as to avoid any collision during the re-introduction of the at least one obstacle, i.e. obstacle 300, into the ROI 126. The adapted state of the kinematic structure 200 is schematically indicated in FIG. 7C by dashed lines representing the adapted links 220 and 230. It is noted that although the two links 220 and 230 of the kinematic structure 200 have been adapted or manipulated to avoid collision with the re-introduced obstacle 300, the number of adaptations is not limited herein. Accordingly, the processing circuitry 120 may be configured to adapt element of the kinematic chain of the kinematic structure 200 that is suitable and/or feasible for avoiding the collision with the obstacle 300. Further, it is noted that the re-introduction of the at least one obstacle, e.g. obstacle 300, may be performed gradually, wherein the processing circuitry 120 may be configured to resolve any overlap or intersection for each step of the re-introduction.

It is noted that although FIG. 7C illustrates the re-introduction of the at least one obstacle, i.e. obstacle 300, from the top of FIG. 7C, this direction may be a different direction thereto, and may be any direction with respect to FIG. 7C.

As illustrated in FIG. 7D, at the end of its re-introduction into the ROI 126, the at least one obstacle, i.e. obstacle 300, may be at its position as estimated. However, due to the collision avoidance carried out during the re-introduction (c.f. FIG. 7C), i.e. due to adapting the state of the kinematic structure 200 accordingly, all of the overlaps and intersections between the kinematic structure 200 and the at least one obstacle, i.e. obstacle 300, are resolved. That is, the at least one obstacle, i.e. obstacle 300, is at its estimated position within the ROI 126 as illustrated in FIG. 7A, but the state of the kinematic structure 200 has been adapted compared to the illustration of FIG. 7A. Thus, if this adapted state of the kinematic structure 200 is used as the target pose, a collision of the kinematic structure 200 with the at least one obstacle, e.g. obstacle 300, can be avoided for the future for which the ROI 126 was estimated. However, the estimation does this by active collision avoidance rather than reactive avoidance when the obstacle is already in the vicinity of the kinematic structure 200. Therefore, the target pose corresponding to or resulting from the adapted state of the kinematic structure 200 as illustrated in FIG. 7D may be used and provided as the above-described target pose data 121.

In at least some examples, the re-introducing of the at least one obstacle, e.g. obstacle 300, into the ROI 126 may comprise re-introducing the at least one obstacle, e.g. obstacle 300, from different directions into the ROI 126 and combining the respective adaptations of the state of the kinematic structure 200 for each direction. For example, with reference to FIG. 7, the at least one obstacle, e.g. obstacle 300, may be re-introduced from the top, left, right, bottom, from the sheet background, from the sheet front, etc. The adapted structures and/or target poses for each individual re-introduction from those directions may then be compared to each other. For example, the one with the most satisfying properties, e.g. with the largest compliance with the current state and/or a desired state of the kinematic structure 200, may be used as the target pose. Alternatively, instead of trying multiple different directions for the re-introduction of the at least one obstacle, the direction may also be determined rule-based with a suitable logic, which may be based, for example, on the size of the obstacle and its relative position to the kinematic structure 200. For instance, the selection of this direction may be performed by using a suitable classifier, such as a neural network trained based on artificial training data created with simulations for different obstacles, obstacle positions and poses of the kinematic structure.

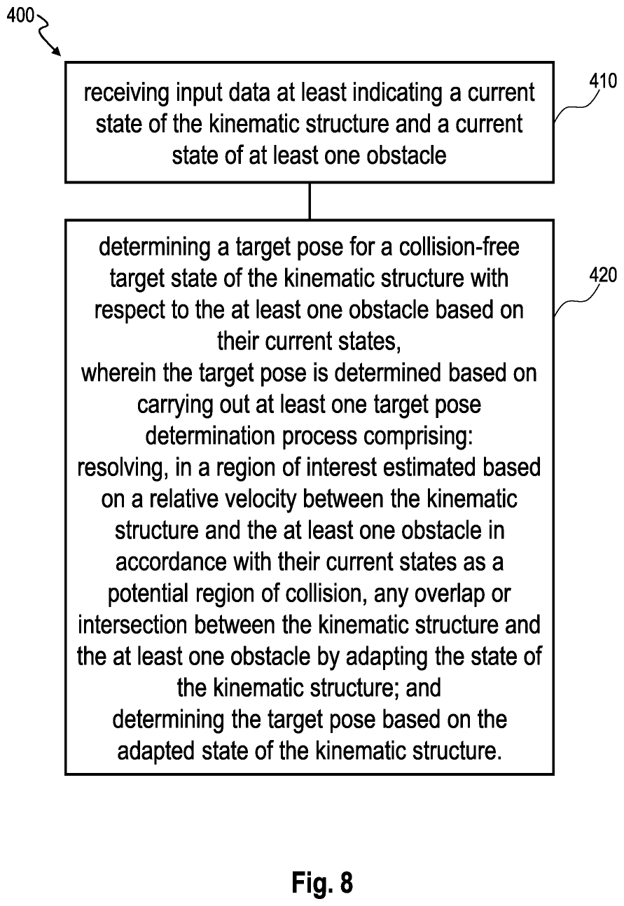

For further highlighting the collision avoidance described above, FIG. 8 illustrates in a flowchart a method 400 of collision avoidance for a kinematic structure. The method comprises receiving 410 pose data indicating a desired pose for the kinematic structure and time data indicating an update interval used to control the kinematic structure. Further, the method comprises determining 420 a target pose for a collision-free target state of the kinematic structure with respect to the at least one obstacle based on their current states. Thereby, the target pose is determined based on carrying out at least one target pose determination process that comprises resolving, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure, and determining the target pose based on the adapted state of the kinematic structure.

The method 400 may allow effective self-collision avoidance and/or obstacle-collision avoidance. By considering the region of interest, i.e. the potential region of collision, for a future time, the method allows an active collision avoidance because resolving any overlap and/or intersection in that region avoids impending collisions well in advance before they are imminent. That is, the kinematic structure does not have to quickly swerve in reaction to a detected object in close proximity, but rather the closeness to that object is (actively) avoided from the beginning. This also allows improved motion of the kinematic structure. In addition, the method requires only little computational effort.

More details and aspects of the method 400 are explained in connection with the proposed technique or one or more examples described above (e.g., FIG. 1 to FIG. 7). The method 400 may comprise one or more additional optional features corresponding to one or more aspects of the proposed technique, or one or more examples described above.

The following examples pertain to further embodiments:

(1) A method of collision avoidance for a kinematic structure, comprising:
receiving input data at least indicating a current state of the kinematic structure and a current state of at least one obstacle; and
determining a target pose for a collision-free target state of the kinematic structure with respect to the at least one obstacle based on their current states,
wherein the target pose is determined based on carrying out at least one target pose determination process comprising:
   resolving, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure; and
   determining the target pose based on the adapted state of the kinematic structure.

(2) The method of (1), wherein adapting the state of the kinematic structure comprises adapting one or more kinematic chain parameters of the kinematic structure.

(3) The method of (1) or (2), wherein the region of interest is distanced from the kinematic structure and/or the at least one obstacle by a relative velocity vector indicating the relative velocity between the kinematic structure and the at least one obstacle.

(4) The method of any one of (1) to (3), wherein the region of interest is estimated by projecting the kinematic structure and/or the at least one obstacle, by a relative velocity vector indicating the relative velocity between the kinematic structure and the at least one obstacle, from a first position corresponding to a position according to the current states of the kinematic structure and the at least one obstacle to a second position corresponding to the region of interest.

(5) The method of any one of (1) to (4), wherein the kinematic structure comprises or is formed of a kinematic chain, and the at least one obstacle is an element of the kinematic chain.

(6) The method of any one of (1) to (5), wherein the at least one obstacle comprises an obstacle separate from the kinematic structure.

(7) The method of any one of (1) to (6), wherein resolving any overlap or intersection between the kinematic structure and the at least one obstacle comprises adapting the state of the kinematic structure to keep a minimum distance between the kinematic structure and the at least one obstacle.

(8) The method of any one of (1) to (7), wherein resolving any overlap or intersection between the kinematic structure and the at least one obstacle comprises:
determining a collision-free initial state of the kinematic structure with respect to the at least one obstacle by removing the at least one obstacle from the region of interest; and
iteratively re-introducing the at least one obstacle into the region of interest and adapting the initial state of the kinematic structure by performing collision avoidance with respect to the at least one obstacle during its re-introduction to obtain the target pose for the region of interest.

(9) The method of (8), wherein, at the end of its re-introduction into the region of interest, the at least one obstacle is at a position estimated for the at least one obstacle.

(10) The method of (8) or (9), wherein re-introducing the at least one obstacle into the region of interest comprises re-introducing the at least one obstacle from different directions into the region of interest and combining the respective adaptations of the state of the kinematic structure for each direction.

(11) The method of any one of (1) to (10), further comprising generating control data for controlling the kinematic structure based on the target pose.

(12) The method of any one of (1) to (11), further comprising performing inverse kinematics on the target pose and generating control data for controlling the kinematic structure based on the inverse kinematics.

(13) The method of (12), wherein performing the inverse kinematics comprises:
receiving pose data indicating the target pose for the kinematic structure and time data indicating an update interval used to control the kinematic structure;
performing a constrained optimization process on inverse kinematics of the target pose in accordance with the time data to obtain for the respective update interval one or more kinematic chain parameters associated with the collision-free target state of the kinematic structure; and
generating control data for controlling the kinematic structure based on the one or more kinematic chain parameters.

(14) The method of (13), wherein the optimization process utilizes a number of cost functions and/or constraints to solve a number of objectives.

(15) The method of (13) or (14), wherein the optimization process comprises penalizing closeness of the kinematic structure to the at least one obstacle to obtain optimized one or more kinematic chain parameters.

(16) The method of any one of (13) to (15), wherein the optimization process comprises penalizing such kinematic chain parameters and/or states of the kinematic structure that violate one or more constraints associated with hardware limitations of the kinematic structure to obtain optimized one or more kinematic chain parameters.

(17) The method of any one of (1) to (16), wherein the target pose determination process is carried out during runtime of the kinematic structure.

(18) The method of any one of (1) to (17), wherein the target pose determination process is carried out multiple times for different kinematic structure information data and obstacle information data to obtain a training data set for training a machine-learning model for determining the target pose for the kinematic structure, and wherein the method further comprises determining the target pose for the kinematic structure by the trained machine-learning model during runtime of the kinematic structure.

(19) An apparatus for collision avoidance of a kinematic structure, comprising:
interface circuitry configured to receive input data at least indicating a current state of the kinematic structure and a current state of at least one obstacle; and
processing circuitry configured to:
   determine a target pose for a collision-free target state of the kinematic structure with respect to the at least one obstacle based on their current states,
   wherein the processing circuitry is configured to determine the target pose based on carrying out at least one target pose determination process comprising:
   resolve, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure; and
   determine the target pose based on the adapted state of the kinematic structure.

(20) A robotic system, comprising:
an apparatus according to (19); and
a robotic device configured to operate based on the target pose.

(21) A non-transitory machine-readable medium having stored thereon a program having a program code for performing the method according to any one of (1) to (18), when the program is executed on a processor or a programmable hardware.

(22) A program having a program code for performing the method according to any one of (1) to (18), when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (F) PGA), graphics processor units (GPU), ASICs, integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Further more, features of a claim should also be included for any other independent claim, even if that claim is not directly defined as dependent on that other independent claim.

What is claimed is:

1. A method of collision avoidance for a kinematic structure, comprising:
receiving input data at least indicating a current state of the kinematic structure and a current state of at least one obstacle; and
determining a target pose for a collision-free target state of the kinematic structure with respect to the at least one obstacle based on their current states,
wherein the target pose is determined based on carrying out at least one target pose determination process comprising:
resolving, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure; and
determining the target pose based on the adapted state of the kinematic structure.

2. The method of claim 1, wherein adapting the state of the kinematic structure comprises adapting one or more kinematic chain parameters of the kinematic structure.

3. The method of claim 1, wherein the region of interest is distanced from the kinematic structure and/or the at least one obstacle by a relative velocity vector indicating the relative velocity between the kinematic structure and the at least one obstacle.

4. The method of claim 1, wherein the region of interest is estimated by projecting the kinematic structure and/or the at least one obstacle, by a relative velocity vector indicating the relative velocity between the kinematic structure and the at least one obstacle, from a first position corresponding to a position according to the current states of the kinematic structure and the at least one obstacle to a second position corresponding to the region of interest.

5. The method of claim 1, wherein the kinematic structure comprises or is formed of a kinematic chain, and the at least one obstacle is an element of the kinematic chain.

6. The method of claim 1, wherein the at least one obstacle comprises an obstacle separate from the kinematic structure.

7. The method of claim 1, wherein resolving any overlap or intersection between the kinematic structure and the at least one obstacle comprises adapting the state of the kinematic structure to keep a minimum distance between the kinematic structure and the at least one obstacle.

8. The method of claim 1, wherein resolving any overlap or intersection between the kinematic structure and the at least one obstacle comprises:
determining a collision-free initial state of the kinematic structure with respect to the at least one obstacle by removing the at least one obstacle from the region of interest; and
iteratively re-introducing the at least one obstacle into the region of interest and adapting the initial state of the kinematic structure by performing collision avoidance with respect to the at least one obstacle during its re-introduction to obtain the target pose for the region of interest.

9. The method of claim 8, wherein, at the end of its re-introduction into the region of interest, the at least one obstacle is at a position estimated for the at least one obstacle.

10. The method of claim 8, wherein re-introducing the at least one obstacle into the region of interest comprises re-introducing the at least one obstacle from different directions into the region of interest and combining the respective adaptations of the state of the kinematic structure for each direction.

11. The method of claim 1, further comprising generating control data for controlling the kinematic structure based on the target pose.

12. The method of claim 1, further comprising performing inverse kinematics on the target pose and generating control data for controlling the kinematic structure based on the inverse kinematics.

13. The method of claim 12, wherein performing the inverse kinematics comprises:
receiving pose data indicating the target pose for the kinematic structure and time data indicating an update interval used to control the kinematic structure;
performing a constrained optimization process on inverse kinematics of the target pose in accordance with the time data to obtain for the respective update interval one or more kinematic chain parameters associated with the collision-free target state of the kinematic structure; and
generating control data for controlling the kinematic structure based on the one or more kinematic chain parameters.

14. The method of claim 13, wherein the optimization process utilizes a number of cost functions and/or constraints to solve a number of objectives.

15. The method of claim 13, wherein the optimization process comprises penalizing closeness of the kinematic structure to the at least one obstacle to obtain optimized one or more kinematic chain parameters.

16. The method of claim 13, wherein the optimization process comprises penalizing such kinematic chain parameters and/or states of the kinematic structure that violate one or more constraints associated with hardware limitations of the kinematic structure to obtain optimized one or more kinematic chain parameters.

17. The method of claim 1, wherein the target pose determination process is carried out during runtime of the kinematic structure.

18. The method of claim 1, wherein the target pose determination process is carried out multiple times for different kinematic structure information data and obstacle information data to obtain a training data set for training a machine-learning model for determining the target pose for the kinematic structure, and wherein the method further comprises determining the target pose for the kinematic structure by the trained machine-learning model during runtime of the kinematic structure.

19. An apparatus for collision avoidance of a kinematic structure, comprising:
interface circuitry configured to receive input data at least indicating a current state of the kinematic structure and a current state of at least one obstacle; and
processing circuitry configured to:
determine a target pose for a collision-free target state of the kinematic structure with respect to the at least one obstacle based on their current states,
wherein the processing circuitry is configured to determine the target pose based on carrying out at least one target pose determination process comprising:
resolve, in a region of interest estimated based on a relative velocity between the kinematic structure and the at least one obstacle in accordance with their current states as a potential region of collision, any overlap or intersection between the kinematic structure and the at least one obstacle by adapting the state of the kinematic structure; and
determine the target pose based on the adapted state of the kinematic structure.

20. A robotic system, comprising:
an apparatus according to claim 19; and
a robotic device configured to operate based on the target pose.
